(19) United States
(12) Patent Application Publication
(10) Pub. No.: US 2009/0087723 A1
(43) Pub. Date: Apr. 2, 2009

(54) HEAT GENERATION MECHANISM-PROVIDED SECONDARY BATTERY

(75) Inventor: Yasushi INDA, Sagamihara (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHARA INC., Sagamihara (JP)

(21) Appl. No.: 12/241,954

(22) Filed: Sep. 30, 2008

(30) Foreign Application Priority Data
Oct. 1, 2007 (JP) 2007-257534

(51) Int. Cl. H01M 10/50

(52) U.S. Cl. 429/62

(57) ABSTRACT

In a secondary battery which is poor in battery properties at a low temperature, by making the temperature of the secondary battery in a state of the largest discharge capacity, a secondary battery which can be used under a condition such as a cold district is obtained. A cell of the battery is configured in a sheet form, and the cell is provided with a heat generation unit capable of generating heat by carrying a current. According to this configuration, the battery can be used at a temperature with good capacity properties regardless of the ambient temperature environment. In particular, in an organic electrolytic liquid-free polymer electrolyte or solid electrolyte-containing lithium ion secondary battery which is high in energy density but poor in battery properties at a low temperature, a sufficient battery performance can be brought out regardless of the temperature environment.

### CROSS REFERENCES TO RELATED APPLICATIONS

The present invention contains subject matter related to Japanese Patent Application No. 2007-257534 filed with the Japan Patent Office on Oct. 1, 2007, the entire contents of which being incorporated herein by reference.

### BACKGROUND OF THE INVENTION

1. Field of the Invention

The present invention mainly relates to a rechargeable battery provided with a heating function.

2. Description of the Related Art

In recent years, from the viewpoints of reduction of global greenhouse gas and energy conservation, a hybrid vehicle mounted with both an engine using gasoline as a fuel and an electric motor is watched as a vehicle which is low in an amount of an exhaust gas and good in fuel consumption. As compared with automobiles with only an internal combustion engine, the hybrid vehicle contains a number of parts including a motor and a battery and is complicated with regard to devices. However, its development and improvement are continued, and diffusion is being advanced.

An electric power source of the hybrid vehicle which is most diffused at present is a nickel-hydrogen storage battery. As compared with automobiles with only a gasoline engine, the nickel-hydrogen battery is good in discharge properties and is able to reduce the fuel consumption or the amount discharged of carbon dioxide to about a half. However, due to an environmental problem or following an increase of needs to realize a long traveling distance by only a battery, an electric power source for hybrid vehicle having an energy density per unit volume or weight is demanded.

A lithium ion secondary battery having a high energy density is expected to be applied as a next-generation electric power source of the hybrid vehicle and developed for practical implementation by respective battery manufacturers and automobile manufacturers. However, in general, the lithium ion battery uses an organic solvent, and therefore, it is risky in ignition at a high temperature. For example, in the case where the lithium ion battery is used as a motor electric power source of automobile, the deterioration of a positive electrode material or the decomposition of an electrolytic liquid is extreme in the environment where the temperature in the vehicle is high, for example, a high outside air temperature or direct sunlight, and following this, the battery causes thermal runaway, whereby the risk of occurrence of liquid leakage or ignition becomes high. Also, in the case where the battery is burst due to an accident or the like, the electrolytic liquid leaks, and the risk of occurrence of ignition or explosion is generated. For those reasons, a guarantee of safety thereto is necessary.

In order to increase the safety of the lithium ion battery, development of a battery using a polymer electrolyte prepared by converting an electrolyte from a liquid to a gel is advanced. By converting the electrolyte into a gel, the liquid leakage of an ignitable organic electrolytic liquid becomes low so that the safety is enhanced. However, the electrolyte of a general polymer battery is a gel prepared by containing an organic electrolytic liquid in a polymer material, and the polymer battery is not substantially different from the lithium secondary battery in the point that an organic electrolyte is contained. In a usual state, there is no anxiety of liquid leakage. However, in the case where the battery itself is overheated, the risk of occurrence of ignition of the organic electrolytic liquid to be contained in the electrolyte is unavoidable.

In recent years, an organic electrolytic liquid-free polymer battery is developed as a battery having higher safety, and a number of reports have been made. An electrolyte of the organic electrolytic liquid-free polymer battery is an electrolyte having an Li salt added in an organic solid polymer. This is a mechanism in which the Li salt becomes in a state that it is dissolved and ionized in the solid polymer, whereby the ionized lithium ion and an anion can move within the organic polymer. Since the polymer battery does not contain an ignitable organic electrolytic liquid, it is free from a risk of occurrence of liquid leakage and high in durability against overheating.

Furthermore, a wholly solid lithium ion secondary battery using an inorganic solid electrolyte which is not combustible is proposed and studied. The electrolyte of this wholly solid battery is constituted of an inorganic material such as glass or ceramics and does not contain an organic electrolytic liquid. Therefore, such a wholly solid battery is free from liquid leakage or a risk of occurrence of ignition, and even when put in a flame, it does not substantially cause ignition. For example, when it is thought to apply the wholly solid battery as an electric power source for hybrid vehicle, it does not generate a short circuit or does not cause ignition even by an accident such as a crash. Therefore, it may be said that the wholly solid battery is the most favorable from the standpoint of safety.

However, the foregoing polymer electrolyte and solid electrolyte involve a problem that in the case where the temperature is low, the ionic conductivity becomes noticeably low. For example, in the environment where the temperature is low as −20 to −30° C., an output of the battery is not substantially obtainable.

In particular, in the case where the use as a motor electric power source of an automobile which should be supposed to be used in a cold district is considered, a sufficient output cannot be exhibited due to its low ionic conductivity in the foregoing low-temperature environment, and the automobile undergoes the generation of electricity and traveling substantially only by an internal combustion engine. In that case, in view of the matter that heavy battery and motor are mounted, the fuel consumption is rather deteriorated as compared with that in usual automobiles not mounted with a hybrid system. Because of such poor low-temperature properties, a polymer battery or a solid type battery using a solid electrolyte has not been sufficiently put into practical use yet.

Patent Document 1: JP-A-2004-171897

### SUMMARY OF THE INVENTION

Under the foregoing circumstances, the invention has been made, and its object is to enable even a secondary battery which is poor in battery properties at a low temperature to realize a sufficient discharge capacity. In particular, in a solid based electrolyte battery which is large in an advantage on safety, the invention is able to make both safety and battery performance compatible with each other by improving the poor low-temperature properties.

The present inventor has found out that by configuring a cell of a secondary battery in a sheet form and providing the cell with a heat generation unit by carrying a current, a sufficient battery performance can be brought even in a battery with a low discharge performance at a low temperature.

### BRIEF DESCRIPTION OF THE DRAWINGS

FIG. 1 is a conceptual view showing a structure of a battery according to the invention.

FIG. 2 is a conceptual view showing a structure in another embodiment of the invention.

### DESCRIPTION OF THE PREFERRED EMBODIMENTS

The configuration of the invention for solving the foregoing problems is hereunder described in detail.

The terms “low temperature” as referred to in the invention mean a temperature which is lower than a temperature at which in various kinds of secondary batteries, the discharge capacity can be optimized. The term “cell” as referred to in the invention means a cell of a set of a positive electrode, an electrolyte and a negative electrode, and the battery of the invention is configured of a single cell or plural cells.

Even in a battery in which the battery properties are deteriorated at a low temperature, for the purpose of obtaining a good discharge capacity, the battery is provided with a heating unit.

In order to heat the whole of the battery simultaneously and uniformly, it is preferable that a cell of a battery composed of a set of a positive electrode, an electrolyte and a negative electrode is configured in a sheet form and that a heat generation unit is provided directly on the cell. In view of the object of the invention, it is desirable that the battery reaches a desired temperature more quickly. Therefore, in order to heat the battery within a short period of time, it is favorable that the thickness of the cell configuring the battery is thin as far as possible. However, when the thickness of the cell is too thin, in view of the matter that the quantity of a heater per unit volume becomes large or the electrode becomes thin, the battery capacity per unit volume becomes small. Therefore, it is desirable to regulate the thickness of the cell preferably at 0.03 mm or more, more preferably at 0.04 mm or more, and most preferably at 0.05 mm or more. On the other hand, when the thickness of the cell is thick, the battery capacity per unit volume increases, whereas it takes a time to heat the battery to an optimal temperature. Accordingly, in order to achieve heating quickly without largely hindering the battery capacity per unit volume, it is desirable to regulate the thickness of the cell preferably at not more than 5 mm, more preferably at not more than 3 mm, and mostly preferably at not more than 2 mm.

In order to control the start or stop of heating with ease, the unit for heating the battery is preferably a unit capable of generating heat by carrying a current.

When the heat generation unit is disposed outside the battery, it takes a time to achieve heating to the inside, an electric power necessary for heating is large, and the efficiency is poor. Therefore, it is preferable to provide the heat generation unit in the inside of the battery. In order to more enhance the heating efficiency, it is preferable to provide the heat generation unit on a current collector of either one or both of the positive electrode and the negative electrode of the cell. In this way, it is possible to heat the battery directly from the inside, to shorten the time necessary for heating and to decrease the electric power. Also, on that occasion, it is desirable that the heat generation unit is insulated from the electrodes of the cell.

As to the kind of the heat generation unit, those which are suitable for inclusion into the battery, such as a unit having a small size, a unit of an electric power saving type or a unit having a high degree of shape freedom, are preferable. For example, what the heat generation unit has at least one of a nickel-containing alloy, a carbon heater, a ceramic heater and a Peltier element is preferable for meeting these requirements. It is more preferable that the heat generation unit is composed of at least one of them.

In order to raise the temperature of the battery in a necessary proportion at a necessary time, it is desirable that the battery of the invention is provided with a temperature control unit for regulating the temperature of the inside of the battery.

In general, it is desirable that the secondary battery is always at a temperature of an optimal region in the discharge capacity. However, according to the configuration of the invention, since the battery can be heated within a short period of time, heating may be started at the time of discharge. Also, there is an advantage that when heating is carried out only at the time of discharge, an electric power to be consumed for heating can be saved. Accordingly, it is preferable that the secondary battery according to the invention is provided with a unit for detecting whether or not the battery is during discharge (during use).

Since it is sufficient to heat the battery to a temperature region where the discharge properties are improved, it is preferable that heating of the battery is carried out only in the case where the temperature of the battery becomes lower than a temperature of a prescribed range. Accordingly, it is preferable that the secondary battery according to the invention is provided with a unit for detecting the temperature of the battery.

In order to control start or stop due to a heat generator, it is preferable to provide a current-carrying control unit for controlling a current into the heat generation unit.

Taking into consideration the foregoing condition for efficiently heating the battery, it is preferable that the temperature control unit in the battery of the invention is provided with a discharge detection unit for detecting whether or not a current flows out from the battery and a temperature sensor for detecting the temperature of the inside of the battery, whereby in the case where discharge is detected by the discharge detection unit, and the temperature in the inside of the battery is not higher than a prescribed temperature, the temperature in the inside of the battery is controlled by carrying a current into the heat generation unit.

When the temperature sensor and the current-carrying control unit are integrated with, for example, a PTC, NTC or CTR thermistor element capable of switching start or interruption of supply of an electric power source while bordering on the prescribed temperature, automatic temperature control can be realized through a simpler structure. The foregoing thermistor element can be utilized as a heater circuit which permits to carry a current only when the temperate is not higher than a desired set temperature. For example, in discharge of a prescribed secondary battery, in the case where an optimal temperature is T° C., when a thermistor element set so as to be connected to an electric power source at not higher than T° C. is disposed on a line for supplying an electric power into a heat generator (heater), an electric power is supplied into the heater only when the battery temperature is not higher than T° C., and it is possible to prevent overheating and to keep an optimal temperature condition.

From the standpoint of keeping a suitable temperature, it is preferable that heating of the battery is started in the case where the temperature is at least 5° C. lower than the initially set temperature T. It is more preferable that heating of the battery is started in the case where the temperature is at least 3° C. lower than the initially set temperature T; and it is further preferable that heating of the battery is started in the case where the temperature is at least 2° C. lower than the initially set temperature T, thereby controlling the temperature of the battery such that the temperature is not decreased by at least 2° C. relative to the set temperature.

It is also possible to integrally configure the temperature control unit and the heat generation unit as a PTC heater in which the resistance varies with self heat generation.

The electric power into the heat generation unit provided in the cell can be supplied from the battery of the invention in which the heat generation unit is disposed or an external electric power source other than the battery or both of them. However, in the case where the temperature of the battery is low, an output of the battery itself is low, and therefore, it is preferable to heat the battery by supplying an electric power into the heat generation unit from the external electric power source.

In view of the object of the invention, though the external electric power source for the heater of the invention may have a small capacity, it is preferably a battery from which an output is sufficiently obtainable under a low temperature condition and which is able to be repeatedly utilized. For that reason, a chargeable/dischargeable battery (for example, general secondary batteries such as a liquid based lithium ion secondary battery, a nickel-hydrogen battery or a lead storage battery), an electric double layer capacitor such as supercapacitors, a fuel cell, a solar battery and the like can be used.

The liquid based lithium ion secondary battery or capacitor is a battery containing an organic electrolytic liquid in the inside thereof. In the case where such a liquid based lithium ion secondary battery or capacitor is used for a heater for heating the battery according to the invention, a battery with a small capacity can be applied so that its risk is low. For example, so far as the secondary battery of the invention is a battery on a scale to be used as a main electric power source of a motor for hybrid vehicle, the battery for the heater is sufficiently a small-sized battery capable of driving a laptop personal computer.

So far as the external electric power source is a rechargeable battery, when after the temperature of the battery of the invention has sufficiently risen, there is room in the electric power of the battery of the invention, by achieving charge from the battery of the invention, an electric power is compensated in proportion to the consumed amount for the heat generation, whereby the battery can be provided for the use of next time. Besides, it is possible to achieve charge into an external battery for heat generation from not only the battery of the invention but a solar battery or other power generation devices such as a wind power generation device. Also, in case of a battery for vehicle, it is possible to achieve charge from regeneration energy from an electric motor.

In the case where a solar battery, wind power generation or the like is used as the external electric power source, it is possible to heat the battery of the invention not only at the time of discharge (time of starting the use) but continuously. In the case where there is room in the electric power, it is further possible to charge the battery of the invention or other external electric power source on standby.

The invention is aimed at a secondary battery which can be also utilized as a main electric power source for, for example, a hybrid vehicle, and it is desirable that the battery of the invention is a battery which nevertheless a high capacity, is high in high-temperature durability and safe.

For that reason, from the standpoint of energy density, it is preferable that the secondary battery to be used in the invention is a lithium ion battery.

From the standpoint of safety, it is preferable that the secondary battery to be used in the invention does not contain an organic electrolytic liquid. In particular, when an inorganic solid electrolyte is used as an electrolyte of the battery, it is high in heat resistance and durability and noninflammable so that it is very safe. Among inorganic solid electrolytes, glass, ceramics, glass ceramics and the like are preferably used in view of ionic conductivity. In particular, oxides are more preferable from the standpoints of safety and a reduction of the environmental load.

For the purpose of ensuring higher safety while realizing the high capacity, it is desirable that the secondary battery to be used in the invention contains a crystal with lithium ion conductivity in the electrolyte. An inorganic crystal with lithium ion conductivity is high in lithium ion conductivity, thermally stable and noninflammable so that its safety is enhanced.

In order to bring the secondary battery to be used in the invention with flexibility, it is desirable that a polymer electrolyte is contained in the electrolyte. By bringing the electrolyte with flexibility, it is possible to bring the cell itself with flexibility. Therefore, it is possible to fold or wind the cell and put it into a battery pack, whereby a degree of freedom of the battery shape is enhanced.

Furthermore, in order to make the battery have high output and very high safety, it is desirable that the electrolyte is formed of a glass ceramic having high ionic conductivity. When the electrolyte of the battery is formed of a glass ceramic with lithium ion conductivity, a lithium ion transference number within the electrolyte is substantially 1. In that case, there is no decrease in the transference number due to the movement of other ion such as an anion, and only a lithium ion moves within the electrolyte. Therefore, it is possible to realize a battery of a long life without causing a side reaction accompanied with heat generation or deterioration.

In the secondary battery to be used in the invention, it is desirable that a crystal with lithium ion conductivity is contained in the positive electrode or negative electrode. When the foregoing crystal is contained, the lithium ion conductivity within the electrode is enhanced. Therefore, the movement of an ion within the electrode becomes smooth so that it is possible to manufacture a high power battery.

Furthermore, when a glass ceramic with lithium ion conductivity is used as a material for containing the foregoing crystalline with lithium ion conductivity, the glass ceramic has high heat resistance. Therefore, even in the case where the battery is exposed to a high temperature, the glass ceramic plays a role for protecting the electrode active material so that it is expected to realize a long life of the secondary battery according to the invention. In the glass ceramic, the higher the temperature, the faster the movement of a lithium ion. Therefore, it is possible to realize a high power battery upon heating.

According to the invention, even in a rechargeable battery having poor low-temperature properties, it is possible to bring out a sufficient performance of the whole of the battery.

The rechargeable battery provided with a heating function according to the invention is specifically described below with reference to the following Examples. Also, how the rechargeable batteries provided with a heating function according to these Examples are excellent is clarified with reference to the following Comparative Examples. However, it should not be construed that the invention is limited to those shown in the following examples, and the invention can be properly modified and carried out within the scope where the gist of the invention is not deviated.

### EXAMPLE 1

An organic electrolyte liquid-free polymer lithium ion secondary battery having an Ni alloy-made heater provided on a current collector was prepared (this polymer lithium ion secondary battery will be hereinafter referred to as “invention battery 1”). Commercially available LiCoO₂ was used as a positive electrode material; an Li metal alloy foil was used as a negative electrode; and a polymer electrolyte prepared by adding, as an Li supporting salt, LiTFSI (lithium trifluoromethanesulfonylimide) to a copolymer of polyethylene and polypropylene was used as an electrolyte.

On an Al foil as a positive electrode current collector, a slurry of a positive electrode material prepared using a solvent was coated and dried to form a positive electrode layer. On the positive electrode layer, a slurry prepared by adding LiTFSI (lithium trifluoromethanesulfonylimide) to a copolymer of polyethylene and polypropylene by using a solvent was coated and dried to form an electrolyte layer. A negative electrode layer prepared by forming an Li alloy as a negative electrode material on a Cu foil as a negative electrode current collector was stuck to the electrolyte layer formed on the positive electrode layer to prepare a cell.

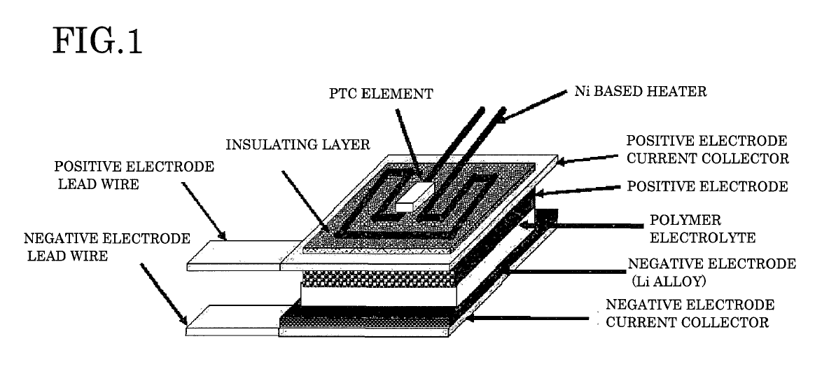

On the positive electrode current collector, a heater circuit prepared by combining an Ni alloy-made heater membrane whose surface was insulated with a polyimide resin and a PTC thermistor element was installed, and these were sealed in an aluminum laminate film, thereby preparing the invention battery 1 composed of a single cell. In sealing, lead wires from the positive and negative electrodes of the cell and lead wires from the PTC element and the Ni based heater were individually insulated, and the wirings were drawn out from the battery; and the lead wires from the positive and negative electrodes were connected to a charge and discharge measuring device of the invention battery 1, whereas the lead wires of the PTC and the heater were connected to a nickel-hydrogen size AA battery as an external electric power source. The cell had a size of 100×100 mm and a thickness of 0.3 mm. A schematic view of the invention battery 1 having this heater function is shown in FIG. 1.

The heater circuit was set such that after charging the invention battery 1 at an ambient temperature of 25° C., the temperature of the invention battery 1 after starting discharge reached 30° C. An electric power is supplied from the nickel-hydrogen battery as an external electric power source, and in the case where the temperature of the invention battery 1 exceeds the set temperature of 30° C. or discharge is stopped, the supply of an electric power is interrupted. Constant-current discharge was carried out at an ambient temperature of 25° C. and 0° C., respectively, and an average operating voltage and a discharge capacity were measured. A charge final voltage was set at 4.2 V; a discharge final voltage was set at 2.5 V; and a discharge current was set at 10 mA. In the case where the ambient temperature of the invention battery 1 was 25° C., the average operating voltage was 3.8 V, and the discharge capacity was 140 mAh. Also, in the case where the ambient temperature of the invention battery 1 was 0° C., the average operating voltage was 3.7 V, and the discharge capacity was 135 mAh; and in comparison with the case where the ambient temperature was 25° C., while the operating voltage was slightly lower at the initial stage of discharge, after a lapse of 10 minutes, it returned to a voltage of the same degree as in the case of 25° C., and a difference was not substantially found.

### COMPARATIVE EXAMPLE 1

A polymer battery was prepared in the same manner as in Example 1, except for not installing the PTC and the heater circuit. Constant-current discharge was carried out at an ambient temperature of 25° C. and 0° C., respectively without controlling the temperature of this battery and an average operating voltage and a discharge capacity were measured. A charge final voltage was set at 4.2 V; a discharge final voltage was set at 2.5 V; and a discharge current was set at 10 mA. In the case where the ambient temperature of this battery was 25° C., the average operating voltage was 3.6 V, and the discharge capacity was 100 mAh. Also, in the case where the ambient temperature of this battery was 0° C., only 3.2 V of the average operating voltage and about 10 mAh of the discharge capacity were obtained.

### EXAMPLE 2

An organic electrolyte liquid-free lithium ion secondary battery having a ceramic heater provided on a current collector was prepared (this lithium ion secondary battery will be hereinafter referred to as “invention battery 2”). Commercially available LiCoO₂ as an active material was used as a positive electrode material; Li₄Ti₅O₁₂ as an active material was used as a negative electrode material; and an organic-inorganic composite electrolyte prepared by mixing a polymer electrolyte prepared by adding, as an Li supporting salt, LiTFSI (lithium trifluoromethanesulfonylimide) to a copolymer of polyethylene and polypropylene with an inorganic solid electrolyte powder was used as an electrolyte. A glass ceramic powder in which an LiTi₂(PO₄)₃ solid solution having a crystal structure of an NASICON type was deposited in a main crystal phase was used as the inorganic solid electrolyte.

On an Al foil as a positive electrode current collector, a slurry of a positive electrode material prepared using a solvent was coated and dried to form a positive electrode layer. On a Cu foil as a negative electrode current collector, a slurry of a negative electrode material prepared using a solvent was coated and then dried to form a negative electrode layer. Both of the positive electrode and negative electrode layers contain a glass ceramic powder in which an LiTi₂(PO₄)₃ solid solution having a crystal structure of an NASICON type is deposited in a main crystal phase as an ion conductive assistant and acetylene black as an electron conductive assistant. To the slurry prepared by adding LiTFSI (lithium trifluoromethanesulfonylimide) to a copolymer of polyethylene and polypropylene as prepared in Example 1, a glass ceramic powder in which an LiTi₂(PO₄)₃ solid solution having a crystal structure of an NASICON type was deposited in a main crystal phase was added, and the mixture was coated on the Li₄Ti₅O₁₂ side of the negative electrode layer and dried to form an electrolyte layer on the negative electrode layer. This electrolyte layer was stuck to the positive electrode layer and subjected to heat contact bonding by a roll press, thereby preparing a cell.

After installing an insulating layer made of a silicon based resin on the positive electrode current collector, a heater circuit prepared by combining a thin ceramic heater membrane and a thermistor element was installed, and these were sealed in an aluminum laminate film, thereby preparing the invention battery 2 composed of a single cell. In sealing, lead wires from the positive and negative electrodes of the cell and a lead wire from the heater circuit were individually insulated, and the wirings were drawn out from the battery; and the lead wires from the positive and negative electrodes were connected to a charge and discharge measuring device of the invention battery 2, whereas the lead wire of the heater circuit was connected to an electric double layer type capacitor as an external electric power source. The cell had a size of 100×100 mm and a thickness of 0.4 mm.

The heater circuit was set such that after charging this battery at an ambient temperature of 25° C., the temperature of the invention battery 2 after starting discharge reached 40° C. An electric power is supplied from the capacitor as an external electric power source, and in the case where the temperature of the invention battery 2 exceeds the set temperature of 40° C. or discharge is stopped, the supply of an electric power is interrupted. Constant-current discharge was carried out at an ambient temperature of 25° C. and 0° C., respectively, and an average operating voltage and a discharge capacity were measured. A charge final voltage was set at 2.7 V; a discharge final voltage was set at 1.5 V; and a discharge current was set at 10 mA. In the case where the ambient temperature of the battery was 25° C., the average operating voltage was 2.5 V, and the discharge capacity was 160 mAh. Also, in the case where the ambient temperature of the invention battery 2 was 0° C., the average operating voltage was 2.5 V, and the discharge capacity was 156 mAh; and in comparison with the case where the ambient temperature was 25° C., while the operating voltage was slightly lower at the initial stage of discharge, after a lapse of 15 minutes, it returned to a voltage of the same degree as in the case of 25° C., and a difference was not substantially found.

### COMPARATIVE EXAMPLE 2

A lithium ion secondary battery was prepared in the same manner as in Example 2, except for not installing the heater circuit. Constant-current discharge was carried out at an ambient temperature of 25° C. and 0° C., respectively without controlling the temperature of this battery, and an average operating voltage and a discharge capacity were measured. A charge final voltage was set at 2.7 V; a discharge final voltage was set at 1.5 V; and a discharge current was set at 10 mA. In the case where the ambient temperature of this battery was 25° C., the average operating voltage was 2.3 V, and the discharge capacity was 80 mAh. Also, in the case where the ambient temperature of this battery was 0° C., only 2.0 V of the average operating voltage and about 20 mAh of the discharge capacity were obtained.

### EXAMPLE 3

A solid electrolyte type lithium ion secondary battery having a PTC thermistor provided on a current collector was prepared (this lithium ion secondary battery will be hereinafter referred to as “invention battery 3”). A glass ceramic containing Li_{1+x+y}(Al, Ga)ₓ(Ti, Ge)₂₋ₓSi_{y}P_{3-y}O₁₂ in a main crystal phase was used as an electrolyte. The glass ceramic was prepared by dissolving oxide raw materials in a Pt pot, casting the thus dissolved molten glass into a stainless steel-made mold and quenching it to obtain glass, followed by again heating the glass for crystallization. The glass ceramic had a size of 50 mm in square, and the both surfaces thereof were ground and polished to process into a disc, thereby forming a solid electrolyte. Commercially available LiCoO₂ as an active material was used as a positive electrode material; Li₄Ti₅O₁₂ as an active material was used as a negative electrode material; a PVdF resin was used as a binder; a glass ceramic powder in which an LiTi₂(PO₄)₃ solid solution having a crystal structure of an NASICON type was deposited in a main crystal phase was used as an ion conductive assistant; and a fine powder of acetylene black was used as an electron conductive assistant.

The positive electrode mixed material having a thickness of 50 μm was formed on an Al foil having a thickness of 20 μm as a positive electrode current collector to prepare a positive electrode; and the negative electrode mixed material having a thickness of 50 μm was formed on a Cu foil having a thickness of 20 μm as a negative electrode current collector to prepare a negative electrode, respectively. The positive electrode, the electrolyte and the negative electrode were stuck to each other such that the respective current collectors were faced outward. On each of the positive electrode and negative electrode current collectors, a polyimide-made insulating layer was formed, and a PTC thermistor circuit was formed thereon. In this thermistor circuit, in the case where the temperature is low (not higher than 40° C.), contact points come into contact with each other, whereby heat is generated by supply of an electric power from the outside.

This cell having a heat generation function imparted thereto was sealed by an aluminum laminate the inside of which had been subjected to an insulation treatment, thereby preparing the invention battery 3 composed of a single cell. Lead wires from the positive and negative electrodes of the cell and a lead wire from the thermistor circuit were individually insulated, and the wirings were drawn out from the battery; and the lead wires from the positive and negative electrodes were connected to a charge and discharge measuring device, whereas the lead wire of the heater circuit was connected to a 18650 type lithium ion secondary battery as an external electric power source. The prepared cell had a size of 55×55 mm and a thickness of 1 mm.

The thermistor circuit was set such that after charging the invention battery 3 at an ambient temperature of 25° C., a current after starting discharge was detected and that and supply of an electric power into the thermistor from the external electric power source was started. When the PTC thermistor included in the invention battery 3 detects discharge of the invention battery 3, an electric power is supplied from the lithium ion secondary battery as the external electric power source, and in the case where the temperature of the invention battery 3 exceeds the set temperature of 40° C. or discharge is stopped, the supply of an electric power is interrupted. Constant-current discharge was carried out at an ambient temperature of 25° C. and 0° C., respectively, and an average operating voltage and a discharge capacity were measured. A charge final voltage was set at 2.7 V; a discharge final voltage was set at 1.5 V; and a discharge current was set at 10 mA. In the case where the ambient temperature of the invention battery 3 was 25° C., the average operating voltage was 2.5 V, and the discharge capacity was 40 mAh. Also, in the case where the ambient temperature of the invention battery 3 was 0° C., the average operating voltage was 2.5 V, and the discharge capacity was 36 mAh; and in comparison with the case where the ambient temperature was 25° C., while the operating voltage was slightly lower at the initial stage of discharge, after a lapse of 10 minutes, it returned to a voltage of the same degree as in the case of 25° C., and a difference was not substantially found.

### COMPARATIVE EXAMPLE 3

A battery was prepared in the same manner as in Example 3, except for not installing the PTC thermistor circuit. Constant-current discharge was carried out at an ambient temperature of 25° C. and 0° C., respectively without controlling the temperature of this battery, and an average operating voltage and a discharge capacity were measured. A charge final voltage was set at 2.7 V; a discharge final voltage was set at 1.5 V; and a discharge current was set at 10 mA. In the case where the ambient temperature of this battery was 25° C., the average operating voltage was 2.1 V, and the discharge capacity was 25 mAh. Also, in the case where the ambient temperature of this battery was 0° C., the operating voltage dropped immediately after discharge and after a while, reached the discharge final voltage. The average operating voltage was about 1.7 V, and the discharge capacity was not more than 10 mAh.

### EXAMPLE 4

A solid electrolyte type lithium ion secondary battery having an Ni alloy-made heater provided on a current collector was prepared (the lithium ion secondary battery will be hereinafter referred to as “invention battery 4”). A glass ceramic containing Li_{1+x+y}(Al, Ga)ₓ(Ti, Ge)₂₋ₓSi_{y}P_{3-y}O₁₂ in a main crystal phase the same as in Example 3 was used as an electrolyte. The glass ceramic had a size of 50 mm in square, and the both surfaces thereof were ground and polished to process into a disc, thereby forming a solid electrolyte. A commercially available Li (Co, Mn, Ni)O₂ ternary system material as an active material was used as a positive electrode material of the battery; Li₄Ti₅O₁₂ as an active material was used as a negative electrode material; a PVdF resin was used as a binder; a glass ceramic powder in which an LiTi₂(PO₄)₃ solid solution having a crystal structure of an NASICON type was deposited in a main crystal phase was used as an ion conductive assistant; and a fine powder of acetylene black was used as an electron conductive assistant.

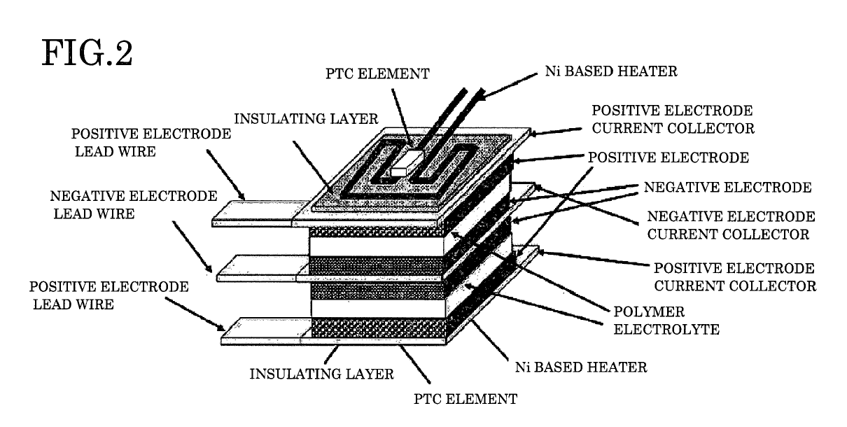

The positive electrode mixed material having a thickness of 70 μm was formed on an Al foil having a thickness of 20 μm as a positive electrode current collector to prepare a positive electrode. The negative electrode mixed material having a thickness of 60 μm was formed on the both surfaces of a Cu foil having a thickness of 20 μm as a negative electrode current collector, thereby preparing a negative electrode having a negative electrode mixed material on the both surfaces of the current collector. The glass ceramic electrolyte was disposed on the both surfaces of the negative electrode, and the prepared positive electrode was stuck to the both sides thereof such that the respective current collectors were faced outward. A cell of the prepared battery had a size of 55×55 mm and a thickness of 1.5 mm. A schematic view of the battery is shown in FIG. 2.

A polyimide-made insulating layer was formed on the positive electrode current collector on the both sides, and a heater circuit prepared by combining an Ni alloy-made heater and a PTC element was formed thereon. In this heater circuit, in the case where the temperature is low (not higher than 40° C.), contact points come into contact with each other, whereby heat is generated by supply of an electric power from the outside. This cell having a heat generation function imparted thereto (of a two-cell structure) was sealed by an aluminum laminate the inside of which had been subjected to an insulation treatment. Lead wires from the positive and negative electrodes of the battery and a lead wire from the heater circuit were individually insulated, and the wirings were drawn out from the battery; and the lead wires from the electrodes were connected to a charge and discharge measuring device, whereas the lead wire of the heater circuit was connected to a solar battery as an external electric power source.

In the solar battery as an external electric power source, a backup lithium ion secondary battery is equipped as a storage battery; and in the case where the solar battery functions as an electric source for heating, the fully charged state is kept, whereas, for example, in the nighttime when the solar battery does not function, supply of an electric power is carried out instead of the solar battery. In the case where the solar battery as an external electric source functions, the invention battery 4 was set so as to always keep the battery temperature at 40° C., whereas in the case where the solar battery does not function, the invention battery 4 was set so as to detect discharge of the invention battery 4, thereby supplying an electric power from the backup lithium ion secondary battery into the heater circuit.

After charging the invention battery 4 at an ambient temperature of 25° C., constant-current discharge was carried out at an ambient temperature of 25° C. and 0° C., respectively, and an average operating voltage and a discharge capacity were measured. A charge final voltage was set at 2.7 V; a discharge final voltage was set at 1.5 V; a discharge current was set at 10 mA; and sunlight was struck on the solar battery. In the case where the ambient temperature of the invention battery 4 was 25° C., the average operating voltage was 2.5 V, and the discharge capacity was 110 mAh. Also, in the case where the ambient temperature of the invention battery 4 was 0° C., the average operating voltage was 2.5 V, and the discharge capacity was 110 mAh, namely these values were exactly the same as those in the case where the ambient temperature was 25° C.

### COMPARATIVE EXAMPLE 4

A battery was prepared in the same manner as in Example 4, except for not installing the PTC element and the heater circuit. Constant-current discharge was carried out at an ambient temperature of 25° C. and 0° C., respectively without controlling the temperature of this battery, and an average operating voltage and a discharge capacity were measured. A charge final voltage was set at 2.7 V; a discharge final voltage was set at 1.5 V; and a discharge current was set at 10 mA. In the case where the ambient temperature of this battery was 25° C., the average operating voltage was 2.0 V, and the discharge capacity was 40 mAh. Also, in the case where the ambient temperature of this battery was 0° C., the operating voltage dropped immediately after discharge and after a while, reached the discharge final voltage. The discharge capacity was 15 mAh so that the usable capacity was a little.

### EXAMPLE 5

An organic electrolytic liquid-free polymer lithium ion secondary battery having an Ni alloy-made heater provided on a current collector was prepared (this polymer lithium ion secondary battery will be hereinafter referred to as “invention battery 5”). The invention battery 5 was prepared so as to have the same structure as in Example 1. The invention battery 5 was connected to a charge and discharge measuring device of the polymer battery in the same manner as in Example 1. However, lead wires from the PTC and heater were connected to the invention battery 5, and an external electric power source was not used. The cell had a size of 100×100 mm and a thickness of 0.3 mm.

The heater circuit was set such that after charging the invention battery 5 at an ambient temperature of 25° C., the temperature of the invention battery 5 after starting discharge reached 30° C. An electric power is supplied into this heater circuit from the invention battery 5, and in the case where the temperature of the invention battery 5 exceeds the set temperature or discharge is stopped, the supply of an electric power into the heater circuit is interrupted. Constant-current discharge was carried out at an ambient temperature of 25° C. and 0° C., respectively, and an average operating voltage and a discharge capacity were measured. A charge final voltage was set at 4.2 V; a discharge final voltage was set at 2.5 V; and a discharge current was set at 10 mA. In the case where the ambient temperature of the invention battery 5 was 25° C., the average operating voltage was 3.8 V, and the discharge capacity was 120 mAh. Also, in the case where the ambient temperature of the invention battery 5 was 0° C., the average operating voltage was 3.6 V, and the discharge capacity was 75 mAh; and in comparison with the case where the ambient temperature was 25° C., while the operating voltage was slightly lower at the initial stage of discharge, after awhile, it returned to a voltage of the same degree as in the case of 25° C. Though the capacity was small in proportion to the electric power to be supplied into the heater circuit at the initial stage of discharge, the capacity of 60% or more in a room temperature state could be discharged.

### COMPARATIVE EXAMPLE 5

A polymer battery was prepared in the same manner as in Example 5, except for not installing the PTC and heater circuit. Constant-current discharge was carried out at an ambient temperature of 25° C. and 0° C., respectively without controlling the temperature of this battery, and an average operating voltage and a discharge capacity were measured. A charge final voltage was set at 4.2 V; a discharge final voltage was set at 2.5 V; and a discharge current was set at 10 mA. In the case where the ambient temperature of this battery was 25° C., the average operating voltage was 3.6 V, and the discharge capacity was 100 mAh. Also, in the case where the ambient temperature of this battery was 0° C., only 3.2 V of the average operating voltage and about 10 mAh of the discharge capacity were obtained.

### EXAMPLE 6

An organic electrolytic liquid-free lithium ion secondary battery having a ceramic heater provided on a current collector was prepared in the same manner as in Example 2 (this lithium ion secondary battery will be hereinafter referred to as “invention battery 6”); and a battery system in which an electric double layer type capacitor as an external electric power source was connected to the heater circuit and the invention battery 6 was prepared.

The heater circuit was set such that after charging the invention battery 6 at an ambient temperature of 25° C., the temperature of the invention battery 6 after starting discharge reached 40° C. The capacitor was set such that in the case where the temperature of the invention battery 6 exceeded 40° C., supply of an electric power from the capacitor as the external electric power source was stopped, and an electric power was then supplied into the capacity as the external electric power source from the invention battery 6, whereby the capacitor was charged until it became in a fully charged state. In the case where discharge of the invention battery 6 is stopped, supply of an electric power into the heater circuit from the capacitor and supply of an electric power into the capacity from the invention battery 6 are also interrupted.

Constant-current discharge was carried out at an ambient temperature of 25° C. and 0° C., respectively, and an average operating voltage and a discharge capacity were measured. A charge final voltage was set at 2.7 V; a discharge final voltage was set at 1.5 V; and a discharge current was set at 10 mA. In the case where the ambient temperature of the invention battery 6 was 25° C., the average operating voltage was 2.5 V, and the discharge capacity was 150 mAh. The capacitor as the external electric power source was in a fully charged state.

Also, in the case where the ambient temperature of the invention battery 6 was 0° C., the average operating voltage was 2.5 V, and the discharge capacity was 135 mAh; and in comparison with the case where the ambient temperature was 25° C., while the operating voltage was slightly lower at the initial stage of discharge, after a lapse of 15 minutes, it returned to a voltage of the same degree as in the case of 25° C. Also, after the invention battery 6 was discharged to the discharge final voltage, the external electric power source was also in a fully charged state, and in comparison with the case where the ambient temperature was 25° C., a substantial difference was not found.

### COMPARATIVE EXAMPLE 6

A lithium ion secondary battery was prepared in the same manner as in Example 2, except for not installing the heater circuit and the external electric power source. Constant-current discharge was carried out at an ambient temperature of room temperature of 25° C. and 0° C., respectively without controlling the temperature of this battery, and an average operating voltage and a discharge capacity were measured. A charge final voltage was set at 2.7 V; a discharge final voltage was set at 1.5 V; and a discharge current was set at 10 mA. In the case where the ambient temperature of this battery was 25° C., the average operating voltage was 2.3 V, and the discharge capacity was 80 mAh. Also, in the case where the ambient temperature of this battery was 0° C., only 2.0 V of the average operating voltage and about 20 mAh of the discharge capacity were obtained.

As described above, by providing the secondary battery with a sensor capable of detecting the temperature or a thermistor capable of controlling the temperature and a heating function-provided heater, even in the case where the temperature of the secondary battery at the time of discharge was low, a high output and a large discharge capacity could be obtained even in an environment of a low ambient temperature.

What is claimed is:

1. A secondary battery configured of a single sheet or plural sheets of a cell having a thickness of 0.03 mm or more and not more than 5 mm, which comprises a heat generation unit by carrying a current.

2. The secondary battery according to claim 1, wherein the heat generation unit is insulated from electrodes of the cell having the heat generation unit disposed therein and provided on a current collector of either one or both of a positive electrode and a negative electrode.

3. The secondary battery according to claim 1, which is provided with a temperature control unit for regulating the temperature of the inside of the battery.

4. The secondary battery according to claim 3, wherein the temperature control unit is provided with a discharge detection unit for detecting whether or not a current flows out from the battery and/or a sensor for detecting the temperature of the inside of the battery and/or a current-carrying control unit for controlling a current into the heat generation unit.

5. The secondary battery according to claim 4, wherein when discharge is detected by the discharge detection unit, and the temperature of the inside of the battery is low, the temperature control unit supplies a current into the heat generation unit by the current-carrying control unit.

6. The secondary battery according to claim 4 or 5, wherein at least one of a PTC, NTC or CTR thermistor element is incorporated into the current-carrying control unit.

7. The secondary battery according to claim 3, wherein the temperature control unit is configured integrally with the heat generation unit as a PTC heater.

8. The secondary battery according to claim 1, wherein the current into the heat generation unit is supplied from an internal electric power source of the battery having a heat generation unit provided therein, an external electric power source other than the battery or both of the internal electric power source and the external electric power source.

9. The secondary battery according to claim 8, wherein the external electric power source other than the battery having a heat generation unit provided therein is at least one member selected among a chargeable/dischargeable battery, a capacitor, a fuel cell and a solar battery.

10. The secondary battery according to claim 9, wherein when the external electric power source other than the battery having a heat generation unit provided therein is a chargeable/dischargeable electric power source, after the temperature of the battery having a heat generation unit provided therein has risen, the external electric power source is charged utilizing an electric power source of the battery having a heat generation unit provided therein.

11. The secondary battery according to claim 1, wherein the heat generation unit is a heat generator having at least one of a nickel-containing alloy, a carbon heater, a ceramic heater and a Peltier element.

12. The secondary battery according to claim 1, wherein the secondary battery is a lithium ion battery.

13. The secondary battery according to claim 1, wherein the secondary battery does not contain an organic electrolytic liquid.

14. The secondary battery according to claim 12, wherein an electrolyte of the secondary battery contains a crystal with lithium ion conductivity.

15. The secondary battery according to claim 12, wherein an electrolyte of the secondary battery contains a polymer electrolyte.

16. The secondary battery according to claim 12, wherein an electrolyte of the secondary battery is a glass ceramic with lithium ion conductivity.

17. The secondary battery according to claim 12, wherein at least one of the positive electrode and the negative electrode contains a crystal with lithium ion conductivity.

18. The secondary battery according to claim 12, wherein at least one of the positive electrode and the negative electrode contains a glass ceramic with lithium ion conductivity.
